(19) United States
(12) Patent Application Publication
(10) Pub. No.: US 2010/0095584 A1
(43) Pub. Date: Apr. 22, 2010

(54) MODULAR WALL ELEMENT FOR GROWING PLANTS AND MODULAR STRUCTURE FORMED BY A PLURALITY OF MODULAR ELEMENTS OF THE AFOREMENTIONED TYPE

(75) Inventors: Philippe Huet, Les Rosiers sur Loire (FR); Laurent Heine, Marigne (FR)

Correspondence Address: YOUNG & THOMPSON, 209 Madison Street, Suite 500, Alexandria, VA, 22314, US

(73) Assignee: HELIOTROPE, Angers Cedex 01 (FR)

(21) Appl. No.: 12/444,850

(22) PCT Filed: Oct. 5, 2007
(86) PCT No.: PCT/FR2007/001636

§ 371 Date: Dec. 3, 2009

(30) Foreign Application Priority Data
Oct. 9, 2006 (FR) 0608818

(51) Int. Cl. A01G 9/02

(52) U.S. Cl. 47/39

(57) ABSTRACT

A wall modular member (1) for cultivating plants, is associated with at least one adjacent similar member (1′) for forming a vertical or inclined vegetal screen on a frame extending in a vertical or inclined plane. The modular member (1) includes at least: a bearing plate (2) that can be coupled with the frame; a gravity flow circulation vector for an aqueous nutriment solution for the plants in the form of a ply or sheet material (6) covering the bearing plate (2); and elements for retaining and/or attaching the plants to the member, in particular to the circulation vector. The vector-defining ply or sheet material (6) extends beyond at least one edge of the bearing plate (2) and defines with its portion protruding from the plate (2) edge a so-called partial-overlap connection strip (9, 10) with an adjacent and similar wall modular member (11).

This invention relates to a modular wall element for growing plants as well as a modular structure formed by a plurality of modular elements of the aforementioned type.

It relates more especially to a modular wall element of the type that is designed to be joined to at least one similar adjacent modular element for forming, on a framework extending essentially in a vertical or inclined plane, a plant screen or wall, vertical or inclined, whereby this modular element comprises at least:
A support slab equipped with means for hanging on said framework,
A vehicle for circulation by gravity flow of an aqueous nutrient solution for the plants that come in the form of a fiber textile or sheet material covering said support slab, and
Means for holding and/or hanging the plants on said element, in particular on the circulation vehicle.

The need to grow plants on vertical or essentially vertical surfaces has arisen in recent years for purposes of allowing the creation of plant walls or screens for purposes of separation or covering. These walls are thus able to conceal an existing wall or to replace a covering wall, such as metallic siding, or else are able to constitute a partition. For a long time, such vertical plant screens had not been developed due to the technical difficulty of maintaining growth on soil on a vertical wall. Actually, the designs that had been developed consisted, including in the case of modular construction, in forming juxtaposed and superposed boxes or pockets, each box or pocket containing a substrate intended to ensure survival of the plants. One example of such embodiments is provided through patents FR-2,860,022, FR-2,857,396, DE 3,316,791 and WO 86/02523. For the sake of simplification of the construction of such plant walls, devices have appeared on the market for growing plants without soil on an essentially vertical surface as illustrated in particular in patent FR-2,634,971. In this type of design, plant hanging supports that come in the form of a material in (a) layer(s) or sheet(s) are intended essentially for hanging and feeding the plants and thus the growth of the plants being ensured by percolation of a liquid substrate through the support or on the surface of the latter. This results in a smaller thickness of the wall and simplified production of the wall that is composed essentially of a rigid support slab and a material in (a) sheet(s) or layer(s).

In the approach described in patent FR-2,634,971, the plant wall is produced by a single support, and a modular construction is not envisioned.

To remedy this problem, the modular approach described in patent FR-2,747,265 was devised. In this case, only the protective wall is made in the form of a modular element and not the support wall and the layer for hanging roots of the plants through which the nutrient solution circulates. This leads to several problems. If the plant wall was installed several years previously, the roots are hung on the layer, making removal impossible. Conversely, this approach makes it possible to ensure continuity of the gravity flow of the nutrient solution over the entire height of the wall, thus limiting the number of watering hoses to be used.

One purpose of this invention is thus to propose a modular wall element for growing plants, whose design makes it possible to ensure continuity of circulation of the nutrient solution between two superposed modular elements and obviates the necessity of, for example, a watering hose for each element.

Another purpose of this invention is to suggest a modular wall element whose design allows easy removal at any time, no matter what its position is in a set of modular elements forming a plant screen.

Another purpose of this invention is to suggest a modular structure for the production of a plant screen, whose design of the modular element allows at the same time continuity of circulation of the plant nutrient solution between at least certain superposed wall elements and visual continuity from one element to another while concealing the junction zones between the support slabs of said elements.

For this purpose, the object of the invention is a modular wall element for growing plants, said element being designed to be joined to at least one similar adjacent modular element for forming, on a framework extending in a vertical or inclined plane, a plant screen or wall, vertical or inclined, whereby this modular element comprises at least:
A support slab that is capable of being coupled to said framework,
A vehicle for circulation by gravity flow of an aqueous nutrient solution for the plants that comes in the form of a material in (a) layer(s) or sheet(s), covering said support slab, and
Means of holding and/or hanging plants on said element, in particular on the circulation vehicle,
   characterized in that the material in (a) layer(s) or sheet(s) that forms the vehicle extends beyond at least one edge of the support slab and forms, with its part projecting from one side of the slab, a strip, i.e., for connecting to a partial covering with a similar, adjacent modular wall element.

Due to the design of such a modular wall element, continuity of circulation of the aqueous solution that is being used to feed the plants from one wall element to another in the case of two superposed wall elements can be ensured without adversely affecting the removal of elements. It is then possible to manage without watering means on certain modular elements in the assembled state of said elements being used to carry the aqueous nutrient solution. The thus ensured continuity of flow of the aqueous nutrient solution from one modular wall element 1 to another likewise makes it possible to save nutrient solution and to reduce the quantity of nutrient solution to be recycled.

Moreover, the design of a vehicle ensuring the circulation of the aqueous plant nutrient solution for purposes of growth of the plants makes it possible to ensure visual continuity at the level of the completed plant screen.

Finally, the modular element design allows such an element to be placed and easily removed, including when the latter is positioned in the center of a set of juxtaposed and/or superposed modular elements forming a plant screen or wall.

The object of the invention is also a modular structure for producing a plant screen, vertical or inclined, characterized in that it is formed by a framework extending in a vertical or inclined plane and by a plurality of modular wall elements of the aforementioned type assembled on the framework in the juxtaposed and/or superposed state.

In one preferred embodiment of the modular structure of the type in which each modular wall element of the aforementioned type comprises a support slab that is provided on its front surface, in the vicinity of at least one of its edges for assembly on a similar adjacent modular wall element with a housing, such as a groove, for accommodating a sealing joint, each modular element is assembled with an adjacent modular element via a section that forms a sealing joint in wave form, whereby this section is extended on either side of the undulation by application wings each bearing a collar that can be elastically deformed, capable of being inserted into the groove of a modular element that is to be assembled.

The framework of the bearing structure of the modular wall elements can be formed at least by crosspieces, said crosspieces having the form of cables or rails. Preferably, the framework of the modular structure bearing the modular wall elements is formed by at least one assembly of uprights and crosspieces forming rails for accommodating support slabs, whereby said support slabs are doubled on the back side by insulation and possibly a facing element.

The invention will be better understood by reading the following description of the embodiments with reference to the attached drawings in which:

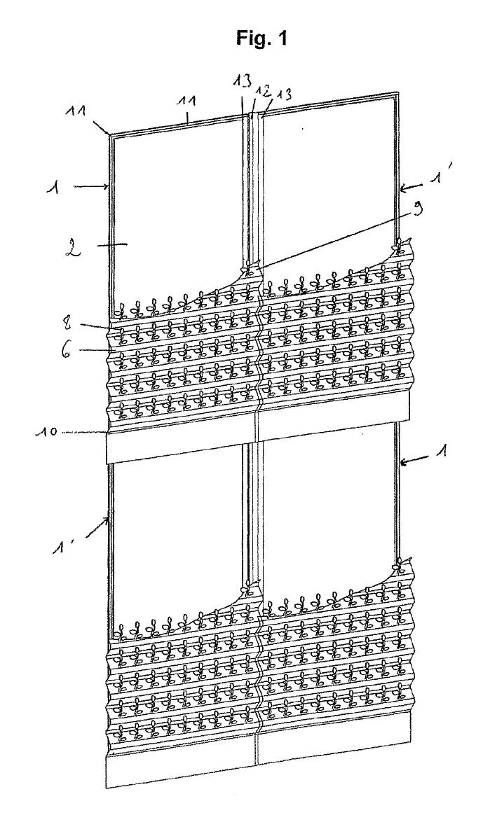

FIG. 1 shows a partial perspective view of a modular structure according to the invention formed by four modular elements;

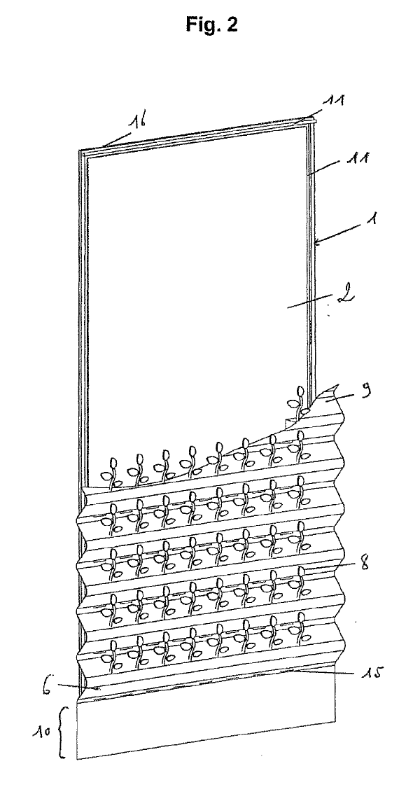

FIG. 2 shows a partial perspective view of a modular element according to the invention;

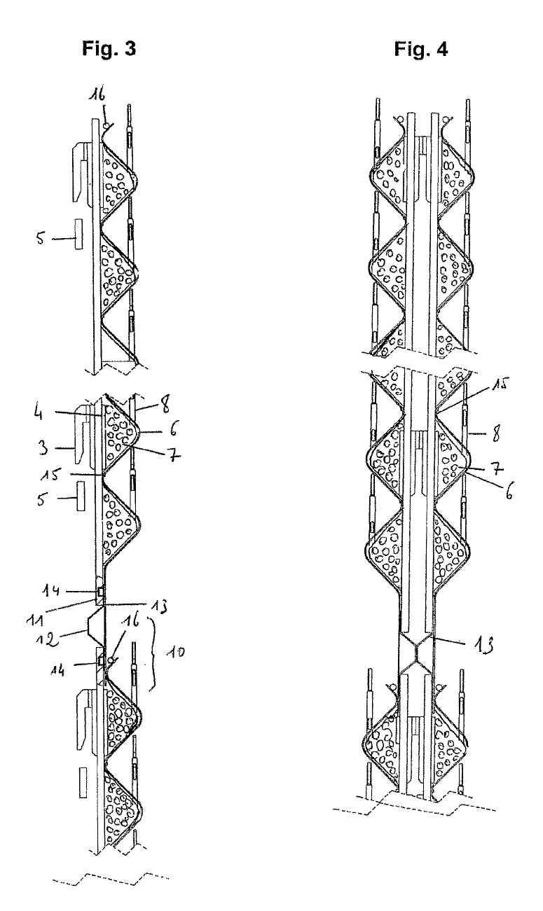

FIG. 3 shows a longitudinal cutaway view of two modular elements according to the invention before assembly on a framework;

FIG. 4 shows a cutaway view of another embodiment of a modular structure formed by four modular elements arranged in pairs on both sides of a bearing framework.

As mentioned above, the object of the invention is a modular wall element 1 for growing plants, whereby this modular element 1 is designed to be joined to at least one similar adjacent modular element 1′, preferably to a plurality of similar adjacent modular wall elements, for forming, in the state of said modular elements being covered by plants, a plant screen, vertical or tilted. Such a plant screen or wall can be used inside or outside in public venues, in particular as a separation and decorative element. This plant screen can likewise be used to conceal existing elements, such as building siding or a roofing section. This screen can likewise replace covering walls, such as siding or roof coverings.

Each modular element 1 comprises at least one support slab 2 of quadrangular shape that is arranged to be coupled to a framework 5 extending in a vertical or inclined plane. To do this, the support slab 2 can be equipped with hanging means 3. The framework 5 working with modular elements in the assembled state by juxtaposition and/or superposition of wall elements on the framework forms a modular structure forming a screen or a plant wall. In the examples shown, the framework 5 has only been partially shown. This bearing framework 5 of the modular wall elements 1 for purposes of producing a modular structure can be formed by crosspieces or uprights and crosspieces, generally assembled at a right angle, whereby at least the crosspieces have the form of cables or rails. In one particular embodiment of the framework, crosspieces and uprights have the form of rails and are equipped with sealing fittings. Quite obviously, other embodiments of such a framework 5 can be envisioned without departing from the framework of the invention. The means 3 of hanging the support slab 2 on the framework 5 in this case have the form of hooks positioned on the back of the support slab 2. Each hook is attached to the slab 2 by an opposing slab 4 placed on the front surface of the support slab 2 and joined to the hook by a suitable linking element. The attachment element connecting the hook and opposing slab 4 can be composed of a rivet, a screw or the like. Once the support slab 2 has been positioned by means of its hooks on the framework 5, an additional axis that crosses the hook transversely can be used to lock the framework, such as a cable or rail, at the inside of said hook and thus to prevent the theft of the modular element 1. This arrangement likewise makes it possible to keep the modular element 1 hung on the framework in bad weather. Regardless of its design, the framework 5 is generally made to define a surface for receiving and supporting modular elements in a vertical or slightly inclined plane. The modular element 1 when positioned on the framework 5 forms with the ground an angle that preferably exceeds 45° so as to allow gravity flow of the aqueous nutrient solution for feeding the plants, which will be described below.

The modular element 1 also comprises a vehicle for circulation by gravity flow of an aqueous nutrient solution that is used for plant growth. This circulation vehicle comes in the form of a material 6 in (a) layer(s) or sheet(s) that covers said support slab 2 and allows a streaming of said nutrient solution. Preferably, this circulation vehicle forms the outer visible surface of said element before the plants are planted. The modular element 1 also comprises means of holding and/or hanging the plants on said element, in particular on the circulation vehicle. These holding and/or hanging means allow the plants to be kept applied to the surface of the support slab 2.

In a manner characteristic of the invention, the material 6 in (a) layer(s) or sheet(s) that comprises the vehicle extends beyond at least one side of the support slab 2 and, with its part projecting from the edge of the slab 2, forms a strip 9, 10, i.e., for connecting to the partial covering with a similar adjacent modular wall element 1′. The part of the material 6 in (a) layer(s) or sheet(s) that projects from the support slab 2 at the same time makes it possible to ensure both visual continuity and continuity of circulation of the nutrient solution of one modular wall element 1 to another without adversely affecting the installation and removal of such a modular element 1 when the latter is inserted within a modular structure formed by juxtaposition and/or superposition of modular elements.

To allow the vehicle that is produced in the form of a material 6 in (a) layer(s) or sheet(s) to ensure circulation by gravity flow of an aqueous nutrient plant solution, the support slab 2 that has two longitudinal parallel edges and two transverse edges, i.e., one the lower, the other the upper, is equipped in the vicinity of one of its edges, i.e., the upper edge, with watering means 16, working with the material 6 in (a) layer(s) or sheet(s). These watering means 16 form feeding means using the aqueous nutrient solution of the vehicle. These watering means 16 come in the form of a generally perforated channel positioned in the vicinity of the upper transverse edge of the support slab 2, parallel to said edge when the support slab 2 is positioned on the framework 5. A watering channel or hose can be connected to the watering channel or hose of an adjacent modular element that is contiguous, in the juxtaposed state, to two similar adjacent modular elements for forming a watering network.

The watering or irrigation network that has been formed in this way is connected to a liquid supply source, in particular a water supply source, to which fertilizers and/or treatment agents are preferably added. The liquid supply source thus likewise comprises a supply source of treatment liquid for the plants. The irrigation network can thus comprise means of routing the water and treatment liquid to the irrigation channels outfitting the support slabs 2 and the means of metering the respective amount of water, treatment liquid and treatment agent, whose implementation is dependent on programming means.

Due to the presence of the connecting strip between two superposed wall elements that is arranged using the vehicle, it is possible to equip only a single row of modular elements with the watering means, the lower row of modular elements being supplied with aqueous nutrient solution by way of the modular elements of the upper row. In this case, the connecting strip extends projecting from the lower transverse edge of the support slab 2 of the wall elements comprising an upper row of the structure and ensures continuity of circulation of the nutrient solution from a so-called upper element to a so-called lower modular element. The covering by the connecting strip 10 located beyond the lower edge of a support slab 2 of an upper element of the upper edge of the vehicle of a lower modular element 1 is more especially apparent in FIG. 3. In FIG. 3, the watering means 16 at the same time equip the support slab of the upper modular element and that of the lower modular element. However, these watering means could have been eliminated at the level of the lower modular element supplied in this case with nutrient solution by the connecting strip between the upper and lower elements.

In the case of a modular structure according to FIG. 1 that has been formed by a plurality of modular elements assembled on a framework 5 extending in a vertical or inclined plane, it is possible to ensure visual continuity from one modular element to another by means of two connecting strips. For this purpose, the material 6 in (a) layer(s) or sheet(s) extends projecting from at least two contiguous edges of the support slab 2 and forms two contiguous connecting strips 9, 10 with partial covering, one 9 of a similar adjacent modular wall element 1′ that has been juxtaposed, the other 10 of a similar adjacent modular wall element 1′ on which said element 1 is superposed. Thus, in the example shown in FIG. 1, the material 6 in (a) layer(s) extends projecting from one so-called longitudinal edge of the support slab 2 and from the lower transverse edge of said support slab to form two connecting strips 9, 10, covering one, from the longitudinal contiguous edge of one adjacent modular element, and the other, from the upper transverse edge of a similar adjacent modular element on which the modular element 1 is superposed.

To enhance the connection between two modular elements and to ensure sealing at the level of this connection, the support slab 2 of the element 1 is equipped on its front surface, in the vicinity of at least one of its edges for assembly on a similar adjacent modular wall element 1′, with a housing 11, such as a groove for accommodating a sealing joint 12. Thus, as shown in FIG. 1, when the modular element when juxtaposed and/or assembled with adjacent modular elements forms a modular structure, each modular element 1 is assembled with an adjacent modular element 1′ by means of a section that forms a sealing joint 12 in wave form. This section is extended on either side of the undulation by application wings 13, each bearing a collar 14 with elastic deformation that can be inserted into the groove of a modular element 1, 1′ that is to be assembled. This design of the sealing joint 12 allows placement and easy removal of each modular element within a set of modular elements. Actually, in the case of damage to the plants outfitting a modular element, it is sufficient to extract, by simply pulling from the front surface of the support slab 2, the joint of the groove of the pertinent module element, then to unhook the modular element from the framework by simply lifting said element to allow the hook to be disengaged from the framework elements before initiating the removal of the modular wall element 1. The design of the joint actually allows play between the modular elements due to the presence of a bellows at the level of the joint, allowing this unhooking by lifting the element without having to move or remove the contiguous wall elements. The joint likewise works with installation of continuity of circulation of the nutrient solution from one element to another.

The material 6 in (a) layer(s) or sheet(s) comprising the vehicle of circulation by gravity flow of an aqueous plant nutrient solution can be made in the form of a single layer. In general, this layer is formed by a tarpaulin or a geotextile, in particular of the Bidime (registered trademark) type or any other type of equivalent drainage covering. In this case, interposed between the circulation vehicle and the support slab, there can be a growth substrate 7, preferably in bulk. Preferably, however, this material in (a) layer(s) or sheet(s) comprises a plurality of formed layers, at least for one layer a tarpaulin that is generally made of a filtering and draining material or a geotextile. Thus, in one preferred embodiment of the invention, this material 6 in (a) layer(s) or sheet(s) is composed of a first water-holding sheet, adjoining the support slab 2 that can allow rooting of the plant roots, and a tarpaulin or a drainage geotextile, i.e., one that does not hold water, such as a material of the Bidime (registered trademark) type. The tarpaulin for itself can be composed of a polypropylene film.

To allow the plants to be placed, the material 6 in (a) layer(s) or sheet(s) is provided with its own openings to allow this placement. The material 6 in a layer is generally made integral with the support slab 2 by fastening. In the example above, slots can thus be provided in the geotextile or the drainage tarpaulin to allow the feet of the plants to be inserted there in order that they can pass through the felt of organic material to be anchored on the water-holding sheet. These slots or openings are made horizontally, i.e., parallel to a transverse edge of the support slab.

Other embodiments of the circulation vehicle can be likewise envisioned. Thus, between the material 6 in (a) layer(s) and the support slab 2, a substrate 7 can be interposed for development of the roots of the plants, in the form of elements in bulk, the material 6 in a layer being then simply formed by a drainage tarpaulin.

In the latter embodiment described above, there are thus openings that are provided in the material 6 in (a) layer(s) or sheet(s) that comprise the means of holding and hanging the plants on the modular element 1.

Other embodiments of these holding means can be envisioned, such as the formation of a pocket or attachment of holding strips to the surface of the vehicle.

In still another embodiment of the invention, a substrate 7 for developing the roots of plants can be interposed between two drainage materials in layers or sheets.

The modular elements 1 are preferably first planted in order to be able to be produced in the form of elements ready to be put on display.

Once the framework 5 has been made by assembling uprights and crosspieces, it is sufficient to initiate the hanging of each modular element on the framework to obtain a modular structure according to the one shown in FIG. 1. The modular elements are assembled among one another, on the one hand, by placing joints between the support slabs at the level of the contiguous assembly edges of said support slabs between them, and, on the other hand, by the positioning of at least one connecting strip of one covering element of the vehicle of one juxtaposed contiguous or adjacent lower modular element 1. This placement is done by simple fastening of the connecting strip. This results in extremely quick placement. It is then enough to initiate the connection of the watering hoses between them and to connect the latter to the nutrient solution supply source to obtain a self-contained modular structure 1.

Such a modular structure can be equipped with means for collecting excess nutrient solution outside of the structure and with means for recirculating the collected excess nutrient solution. These collecting means can be provided at the base of the modular structure, for example in the form of a gutter.

In the case one of the modular elements of the structure is damaged, such an element can be removed extremely easily. This results in a major advantage for maintenance of such a structure. The combination of such modular elements allows the production of a modular structure forming a plant wall that can comprise a partition or can cover work, whereby this plant wall can be installed inside or outside. This wall can be positioned vertically or slightly inclined to cover a roof, for example. Such a plant wall ensures a noise abatement effect and likewise ensures air conditioning of the venues in which it has been installed. It likewise improves the air quality by capturing dust. Finally, due to its modular design, this wall can appear differently in each season by the modular elements comprising said wall being rearranged.

In the embodiment of FIG. 4, the structure comprises modular elements that are located on the same framework 5, on either side of the surfaces that comprise said framework, and that are designed to form a plant screen, in cooperation with the bearing framework 5. Thus, a double-surface plant screen is produced.

1. Modular wall element (1) for growing plants, said element (1) being designed to be joined to at least one similar adjacent modular element (1′) for forming, on a framework (5) extending in a vertical or inclined plane, a plant screen or wall, vertical or inclined, whereby this modular element (1) comprises at least:
A support slab (2) that is capable of being coupled to said framework (5),
A vehicle for circulation by gravity flow of an aqueous nutrient solution for plants that come in the form of a material (6) in (a) layer(s) or sheet(s) covering said support slab (2), and
Means (15) for holding and/or hanging the plants on said element (1), in particular on the circulation vehicle, characterized in that the material (6) in (a) layer(s) or sheet(s) forming the vehicle extends beyond at least one edge of the support slab (2) and forms, with its part projecting from one edge of the slab (2), a so-called connecting strip (9, 10) for partial covering with a similar, adjacent modular wall element (1′).

2. Modular element (1) according to claim 1, wherein the material (6) in (a) layer(s) or sheet(s) comprises a plurality of formed layers, at least for one layer a tarpaulin or a geotextile.

3. Modular element (1) according to claim 1, wherein the material (6) in (a) layer(s) or sheet(s) is provided with its own openings to allow placement of plants (8) and is made integral with the support slab (2) by fastening.

4. Modular element (1) according to claim 1, wherein the material (6) in (a) layer(s) or sheet(s) extends projecting from at least two contiguous edges of the support slab (2) and forms two continuous connecting strips (9, 10) with the partial covering, one (9) of a similar adjacent modular wall element (1′) that has been juxtaposed, the other (10) of a similar adjacent modular wall element (1′) on which said element (1) is superposed.

5. Modular element (1) according to claim 1, wherein the support slab (2) of said element (1) is equipped on its front surface, in the vicinity of at least one of its edges for assembly on a similar adjacent modular wall element (1′), with a housing (11) such as a groove for accommodating a sealing joint (12).

6. Modular element (1) according to claim 1, wherein the support slab (2) is equipped in the vicinity of one of its edges, i.e., the upper edge, with watering means (16), working with the material (6) in (a) layer(s) or sheet(s) to allow circulation of the aqueous nutrient solution for watering by gravity within said material (6).

7. Modular structure for producing a plant screen, vertical or inclined, wherein it is formed by a framework (5) extending in a vertical or inclined plane and by a plurality of modular wall elements (1) according to claim 1, assembled with the framework (5) in the juxtaposed and/or superposed state.

8. Modular structure according to claim 7 of the type in which each modular wall element (1) comprises a support slab (2) that is equipped on its front surface, in the vicinity of at least one of its edges for assembly on a similar adjacent modular wall element (11), with a housing (11) such as a groove for accommodating a sealing joint (12), wherein each modular element (1) is assembled with an adjacent modular element (1′) via a section that forms a sealing joint (12) in wave form, this section being extended on either side of the undulation by application wings (13), each bearing a collar (14) with elastic deformation, capable of being inserted into the groove of a modular element (1, 1′) to be assembled.

9. Modular structure according to claim 7, wherein the framework (5) of the modular structure, bearing the modular wall elements (1), is formed at least by crosspieces, whereby said crosspieces assume the form of cables or rails.

10. Modular structure according to claim 7, wherein the framework (5) of the modular structure bearing the modular wall elements (1) is formed by at least one assembly of uprights and crosspieces forming rails for accommodating the support slabs (2), whereby said support slabs (2) are doubled on the back side by insulation and possibly a facing element.

11. Modular element (1) according to claim 2, wherein the material (6) in (a) layer(s) or sheet(s) is provided with its own openings to allow placement of plants (8) and is made integral with the support slab (2) by fastening.

12. Modular element (1) according to claim 2, wherein the material (6) in (a) layer(s) or sheet(s) extends projecting from at least two contiguous edges of the support slab (2) and forms two continuous connecting strips (9, 10) with the partial covering, one (9) of a similar adjacent modular wall element (1′) that has been juxtaposed, the other (10) of a similar adjacent modular wall element (1′) on which said element (1) is superposed.

13. Modular element (1) according to claim 2, wherein the support slab (2) of said element (1) is equipped on its front surface, in the vicinity of at least one of its edges for assembly on a similar adjacent modular wall element (1′), with a housing (11) such as a groove for accommodating a sealing joint (12).

14. Modular element (1) according to claim 2, wherein the support slab (2) is equipped in the vicinity of one of its edges, i.e., the upper edge, with watering means (16), working with the material (6) in (a) layer(s) or sheet(s) to allow circulation of the aqueous nutrient solution for watering by gravity within said material (6).

15. Modular structure for producing a plant screen, vertical or inclined, wherein it is formed by a framework (5) extending in a vertical or inclined plane and by a plurality of modular wall elements (1) according to claim 1\2, assembled with the framework (5) in the juxtaposed and/or superposed state.

16. Modular structure according to claim 8, wherein the framework (5) of the modular structure, bearing the modular wall elements (1), is formed at least by crosspieces, whereby said crosspieces assume the form of cables or rails.

17. Modular structure according to claim 8, wherein the framework (5) of the modular structure bearing the modular wall elements (1) is formed by at least one assembly of uprights and crosspieces forming rails for accommodating the support slabs (2), whereby said support slabs (2) are doubled on the back side by insulation and possibly a facing element.
